(19) United States
(12) Patent Application Publication
(10) Pub. No.: US 2026/0359181 A1
(43) Pub. Date: Nov. 12, 2026

(54) METHOD TO DETERMINE THE CAPACITY OF DATA CENTER CPUS

(71) Applicant: Intel Products IP LLC, Santa Clara, CA (US)

(72) Inventor: Christopher Michael MACNAMARA, Limerick (IE)

(21) Appl. No.: 19/719,683

(22) Filed: Jun. 25, 2026

(51) Int. Cl. G06F 11/30; G06F 11/34

(52) U.S. Cl. CPC G06F 11/3024; G06F 11/3062; G06F 11/3409

(57) ABSTRACT

Methods to determine the capacity of data center CPUs and associated apparatus. The CPU has processor cores having adjustable frequencies including a base frequency and a turbo limit frequency. The core capacity of a core is determined by accessing the current utilization of the core and the current frequency of the core. A headroom for the core is determined at least in part as a function of the current utilization and current frequency, and the core capacity is then calculated at least in part as a function of the current headroom and one of the base frequency or the turbo limit frequency. The core capacity may be used in a closed-loop control process to adjust the frequency of the core in response to changes in its workload. Alarm logic may be used to detect when the core capacity reaches a threshold and adjust its frequency.

### BACKGROUND INFORMATION

Data centers use dynamic voltage and frequency scaling (DVFS) to adjust processor speed (central processing unit (CPU) frequency) and power based on workload demands. By dynamically reducing voltage and clock frequency during idle or low-workload periods, data centers significantly reduce energy consumption and cooling costs. Conversely, this technique can also be used for “DVFS boosting” to safely squeeze extra throughput out of servers during peak computing loads.

Traditional data center capacity planning relies on utilization measured at current CPU frequency, which overestimates saturation when cores are power- or policy-throttled, leading to false alarms, premature scaling, and inefficient capacity forecasts. For example, today's state of the art uses raw CPU utilization, run-queue depth, or Instruction Per Cycle heuristics and then layers heuristics on top (debounce, longer windows, governor hints). These approaches react to symptoms but cannot distinguish real compute demand from frequency-induced artifacts, so automation either triggers too early, too late, or oscillates.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating power states (P-states) and associated core frequencies for an exemplary CPU;

FIG. 2 is diagram illustrating examples of CPU operating conditions and associated CPU capacities determined using a current approach;

FIG. 3 is a diagram illustrating a closed-loop control scheme using core capacity (u2) to prevent false alarms, according to one embodiment;

FIG. 4 is diagram illustrating selected components of an eBPF with power management architecture, according to one embodiment;

FIG. 5 is a flowchart illustrating an eBPF-based governor workflow, according to one embodiment;

FIG. 6 is a diagram illustrating a system architecture supporting enhanced eBPF observability tools, according to one embodiment;

FIGS. 7a and 7b are diagrams of respective embodiments of software architectures illustrating user space and kernel space components; and

FIG. 8 is a diagram of a compute node or compute platform that may be implemented with aspects of the embodiments described and illustrated herein.

### DETAILED DESCRIPTION

Embodiments of methods to determine the capacity of data center CPUs and associated apparatus are described herein. In the following description, numerous specific details are set forth to provide a thorough understanding of embodiments disclosed herein. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

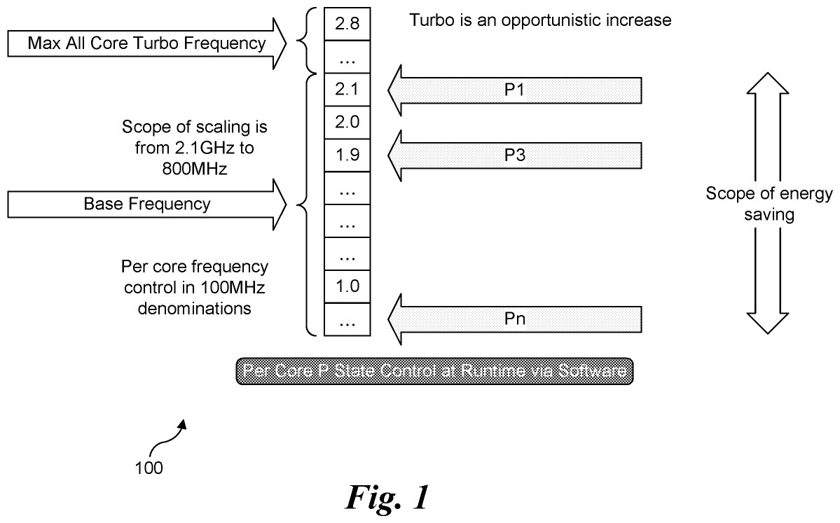

FIG. 1 shows a diagram 100 illustrating power states (P-states) and associated core frequencies for an exemplary CPU. Each core has a base frequency (base_frequency or b_freq) that can be scaled up and down by software and/or firmware. The max all core turbo frequency, also referred to as the turbo limit frequency (f_turbo), is defined in a set of registers, in one embodiment, also called turbo ratio limits. Depending on the number of cores “active”, the turbo frequency set at runtime will be somewhere between the base/P1 and the turbo ratio limits.

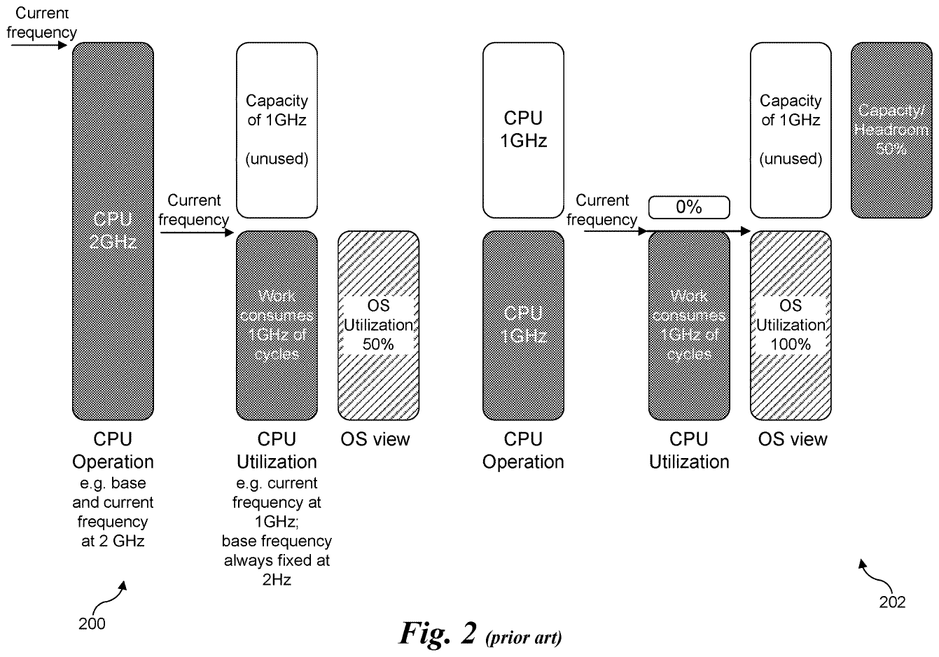

An example of a problem currently encountered in today's data center compute platforms, such as compute servers and the like, is shown in FIG. 2. Under operating condition 200 shown on the left side of FIG. 2, the compute platform CPU is operating at a frequency of 2 GHz, with 1 GHz of CPU cycles being consumed by work (e.g., workload processes executing on the processor cores of the CPU). As a result, the CPU capacity, which represents CPU resources that are not being consumed, is 1 GHz. From the operating system viewpoint, the OS sees a CPU utilization of 50%.

Now compare this with an operating condition 202 shown on the right side of FIG. 2. Under this condition, the CPU frequency has been reduced to 1 GHz. For example, the clock frequency of a CPU may be throttled for various reasons, such as to reduce the power consumed by the CPU. The workload hasn't changed from operating condition 200—the work continues to consume 1 GHz of CPU cycles. However, at an operating frequency of 1 GHz, the CPU capacity under the current workload is 0%. From the operating system's viewpoint, the CPU utilization is 100%, thus as far as the OS is concerned, there is no available capacity or headroom. However, since the CPU's frequency can be returned to 2 GHz, the actual CPU capacity or headroom is 50%.

In accordance with aspects of the embodiments disclosed herein, improved methods for determining the capacity of data center CPUs are provided. Creation of a new lens called “core capacity” turns today's CPU utilization from a frequency-dependent symptom into a normalized, hardware-aware signal of true compute demand, unlocking better efficiency, stability, and automation across the entire data center. Using the core capacity approach normalizes demand against base or turbo reference frequency, giving operators a true view of available compute headroom, enabling more accurate capacity determination, fewer spurious alerts, and higher safe utilization of existing infrastructure.

While raw utilization tells you how hard the CPU is working at the moment, core capacity tells you how close the CPU is to its true performance limit. This is advantageous in data center deployments. The new core capacity metric may be used for not only CPUs, but also for accelerators, graphic processor units (GPUs), XPUs, and various types of devices attached to a compute platform that record utilization against current frequency.

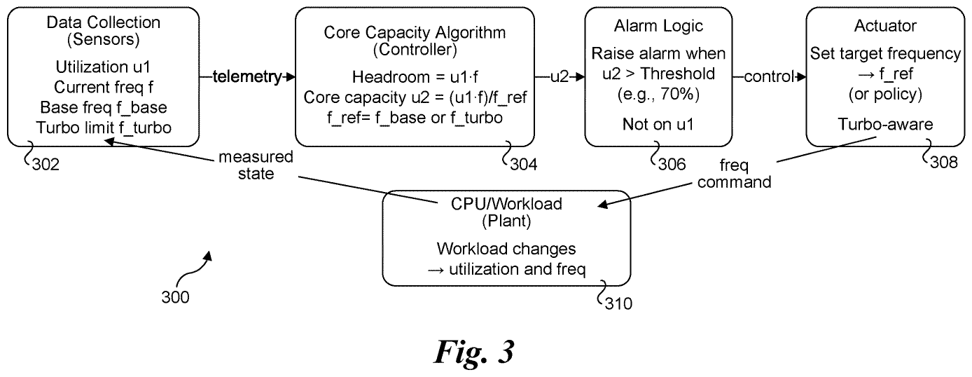

FIG. 3 shows a diagram 300 illustrating a closed-loop control scheme using core capacity (u2) to prevent false alarms, according to one embodiment. The block-level components include data collection 302, a core capacity algorithm 304 implemented by a controller, alarm logic 306, and actuator 308, and a CPU/workload 310.

Data collection 302 implements a data collection function. The data are collected using sensors and include current core utilization “u1” (utilization at the current frequency), current core frequency ‘f,” the base frequency of the CPU “f_base,” and the turbo frequency limit f turbo.

The controller implements a core capacity algorithm 304 to determine a core capacity referred to as “u2.”. The algorithm employs following calculations:

Headroom=u1·f

Core capacity u2=(u1·f)/f_ref

Where f_ref=f_base or f_turbo.

For example, u1=(utilization at current frequency): frequency_headroom=(u1*current frequency) e.g. 50% of 1.5 GHz=0.75 GHz headroom. Suppose base_frequency=2 GHz. u2=(frequency_headroom/base_frequency) e.g. 0.75/2 GHz=0.375 or 37.5% utilization.

Alarm logic 306 raises the alarm when u2>Threshold, which is a user programmable threshold. Suppose the threshold is 70%. Core capacity u2 is the amount of headroom compared to the base frequency and not the current frequency; thus the alarm is raised when u2 is above the user programmable threshold of 70% of utilization ONLY and not when u1 goes past this threshold, which is the case today.

Actuator 308 implements an actuator function. When u2 goes above the threshold, the frequency of the CPU is increased to a base frequency (base_frequency). The actuator function also handles the case when turbo boost is allowed, meaning, the base_frequency is the turbo frequency when turbo boost is enabled.

CPU/workload 310 represents the current CPU workload. The workload changes affect utilization, while CPU frequency may be varied in response to workload changes and other considerations.

Under the control loop, data collection 302 collects data using sensors for u1, current frequency f and the base and turbo limit frequencies f_base and f_turbo, which corresponds to the measured state of CPU/workload 310. Data collection 302 provides corresponding telemetry data as inputs to the core capacity algorithm 304 implemented by the controller. The controller uses the core capacity algorithm to output a current core capacity “u2” value, which is received as an input to alarm logic 306. Alarm logic 306 outputs a control signal when the alarm is raised, which is received as an input by actuator 308. Actuator 308 sets the target frequency as issues a corresponding frequency command to the CPU. The control loop is repeated in an ongoing manner.

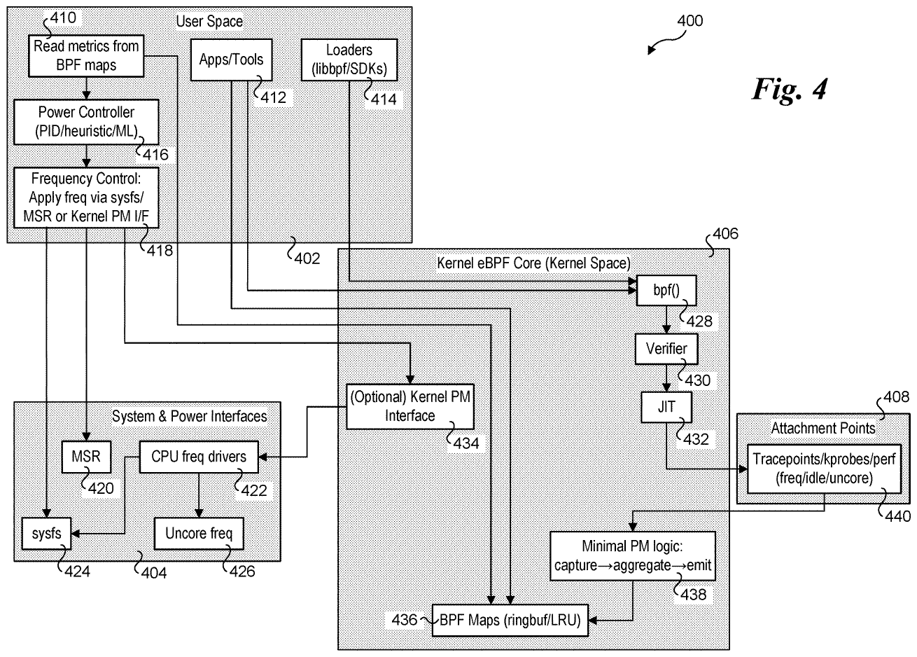

According to further aspects of some embodiments, collection of and access to telemetry data used in the control loops is facilitated, in part, via used of Extended Berkely Packet Filter (eBPF) software components. For example, FIG. 4 shows a diagram 400 illustrating selected components of an eBPF with power management architecture, according to one embodiment. The components are grouped into user space 402, system & power interfaces 404, kernel eBPF core 406 operating in kernel space, and attachment points 408.

Components implemented in user space 402 include read metrics from BPF maps block 410, applications and tools 412, loaders 414, a power controller 416, and a frequency control block 418 that applies frequencies via sysfs and model specific registers (MSR) or via a kernel power management (PM) interface. In the illustrated embodiment, loaders 414 included Linux libbfp and associated SDKs (software development kits).

System and power interfaces 404 include MSR 420, CPU (central processing unit) frequency drivers 422, sysfs 424, and uncore frequency 426. sysfs is a component provided by the Linux kernel that enables kernel code to export information to user processes via an in-memory file system. This includes exporting information about various kernel subsystems, hardware devices, and associated device drivers from the kernel's device model to user space. As used herein, uncore frequency is the frequency used for various components/blocks on a CPU or System on a Chip (SoC) that is outside the processor cores.

Kernel eBPF core 406 are the eBPF core components implemented in the kernel and include a bpf( ) application program interface (API) 428, an eBPF code verifier 430, a just-in-time (JIT) compiler 432, an optional kernel PM interface 434, BPF maps 436, and a minimal power management (PM) block 438. bpf( ) API 428 operates as a Linux kernel API that enables eBPF programs (code) to be loaded into the Linux kernel. Attachment points 408 includes tracepoints, kernel probes (kprobes), and perf block 440. The attachment points are used to control/adjust processor core frequencies, idle states, and uncore frequencies.

Loader 414 in user space 402 are used to load eBPF programs into kernel space via bpf( ) API 428, while read metrics from BPF maps block 410 reads aggregated metrics from BPF maps 436. Power controller 416 consumes map data received from read metrics from BPF maps block 410 and implements a control loop using one of more of a PI (proportional-integral), PID (proportional-integral-derivative), heuristic, or machine learning (ML) algorithms to drive changes by providing frequency control inputs to frequency control block 418. Frequency control block 418 is also used to apply changes by connecting to sysfs 424 and MSR 420 or kernel PM interface 434.

The components in kernel eBPF core 406 are used to attach to stable tracepoints/perf events (freq, idle, uncore), as represented by kprobes/tracepoints/perf events under attachment points 408. The kernel eBPF core also maintain per-CPU/per-package metrics in BPF maps 436, as depicted by minimal PM logic block 438→BPF maps 436. In one embodiment, BPF map 436 comprises a ring buffer that holds ring buffer events and operates as a type of database. In one embodiment the ring buffer uses a least recently used (LRU) hash for MAs. Minimal PM logic keeps the kernel logic at a minimal level. In one embodiment minimal PM logic implements capture→aggregate→emit scheme with no policy loops in eBPF.

The eBPF with power management architecture enables custom eBPF power management programs to be loaded from user space into the kernel using loaders 414. The loaders use the bpf( ) function calls, which operate as an API into the Linux kernel. The eBPF verifier 430 is used to verify the eBPF program, which comprises eBPF type code that is compiled using JIT compiler 432. The eBPF code is generally implemented as observability code or governors that is inserted into the kernel using the foregoing mechanism.

In one embodiment, tracepoints, kprobes, and perf block 440 include some predefined trace points and performance events in the kernel. Generally, a trace point is a function or a symbol, or a metric that can be extracted via the compiled eBPF program. For example, these might include frequency idler, encore frequency, or encore status, C-state residency, etc.

The capture, aggregate, and emit operations essentially take the attached functions, symbols, and/or metrics and adds them as ring buffer events to BPF maps 436. Those ring buffer events are exposed to and read by read metric from BPF maps block 410, as discussed above.

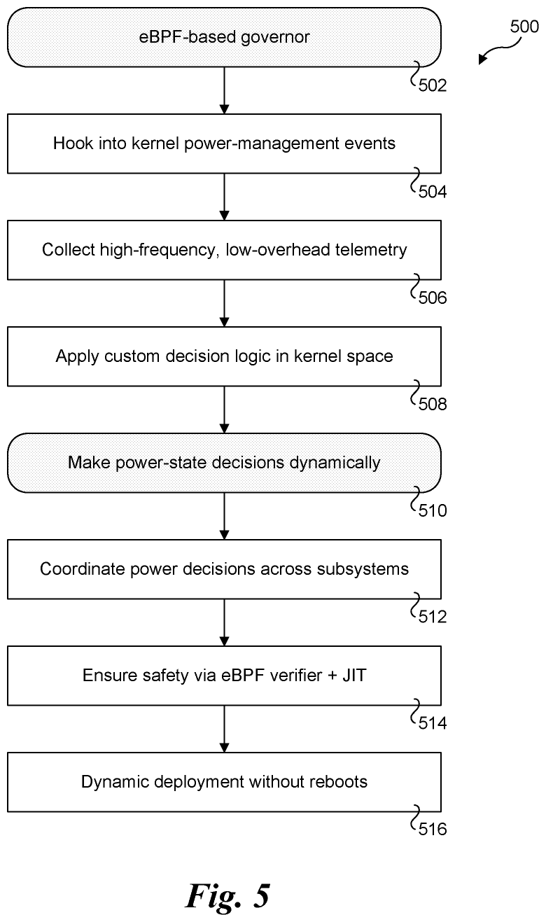

FIG. 5 shows a flowchart 500 illustrating an eBPF-based governor workflow, according to one embodiment. The workflow begins with an eBPF-based governor 502. The eBPF-based governor hooks into kernel power-management events that are maintained in BPF maps 436, gathers high-frequency, low-overhead telemetry data, and applies custom decision logic in the kernel space, as respectively shown in blocks 504, 506, and 508.

As shown in a block 510, the eBPF-based governor makes power-state decisions dynamically. This entails coordinating power decisions across subsystems, ensuring safety via eBPF verifier 430 and JIT compiler 432, and dynamic deployments without reboots, as respectively shown blocks 512, 514, and 516.

### Observability Tools

The eBPF architecture and framework may also be used to enhance observability. eBPF governors and eBPF programs targeted at observability will enable user space applications and the like to not only have improved observation of platform events but also be able to access causal information. For example, compare the following.

Today, a sampling model with powertop periodically observes a CPU state such as “something woke the CPU up,” but provides no or little insight into the cause of the event. For instance, the observation may include.
t0: CPU in C6
t1: CPU in C0
t2: Freq 3.2 GHz

Under an eBPF observability tool(s), the following may be observed.
sched_wakeup→tid=123→comm=pkt-fwd
cpu_idle_exit→state=C6
cpu_frequency→old=800 MHz new=3200 MHz
irq_handler_entry→net_rx

With these addition observation details, we can now observe, “Thread X caused the CPU to exit C6 via sched_wakeup, triggered by IRQ Y, leading to a frequency ramp.”

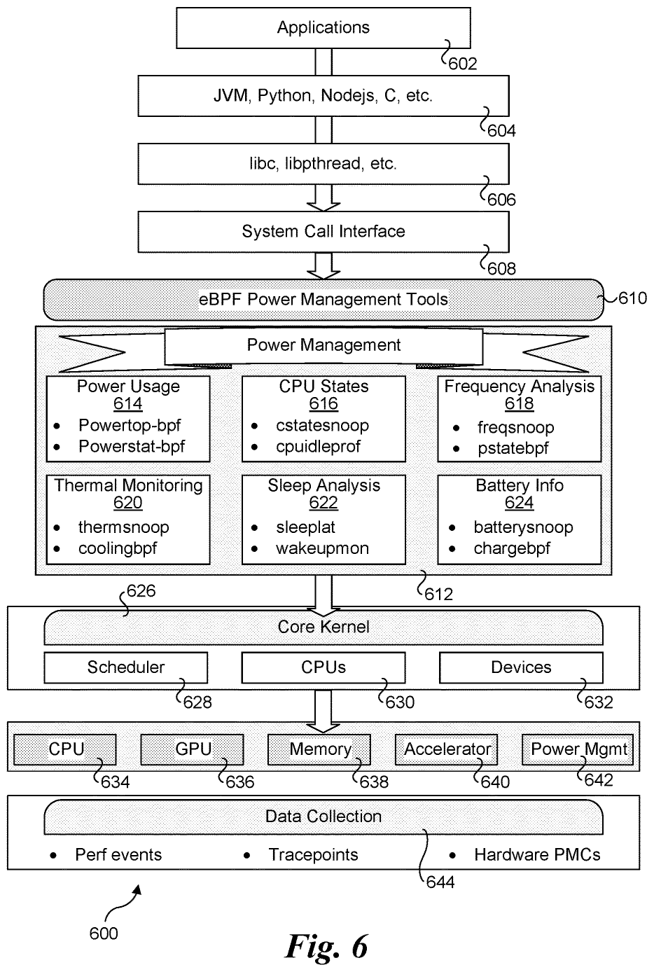

FIG. 6 shows a system architecture 600 supporting enhanced eBPF observability tools. Architecture 600 includes applications 602 running in user space that are programmed using program languages 604 and libraries/frameworks 606. These applications (e.g., eBPF programs) access eBPF power tools 610 via a system call interface 608, such as using bpf( ) system calls.

The exemplary eBPF power management tools 612 include power usage tools 614, CPU state tools 616, frequency analysis tools 618, thermal monitoring tools 620, sleep analysis tools 622 and battery information tools 624. The eBPF power management tools are enabled to access core kernel 626, which provides access to a schedular 628, CPUs 630, and devices 632. This provides observability of a CPU 634, a GPU 636, memory 638, an accelerator 640, and power management hardware 642. Data collection 644, including performance events, tracepoints, and hardware performance monitor counters (PMCs), is used to populate the observability data that are available to the eBPF power management tools.

Exemplary eBPF power management tools are shown in TABLE 2 below.

TABLE 2

| | |
|---|---|
| powertop-bpf | eBPF-based power attribution vs sampling model |
| | (Powertop-like, but trace-driven) |
| powerstat-bpf | Energy/pkg/domain deltas over workload time |
| cstatesnoop | Tracing entry/exit + residency of CPU C-states |
| pstatebpf | Observing frequency transitions + governors |
| thermsnoop | Thermal zone events, throttling causes |
| Batterysnoop? | Platform energy source/discharge attribution |

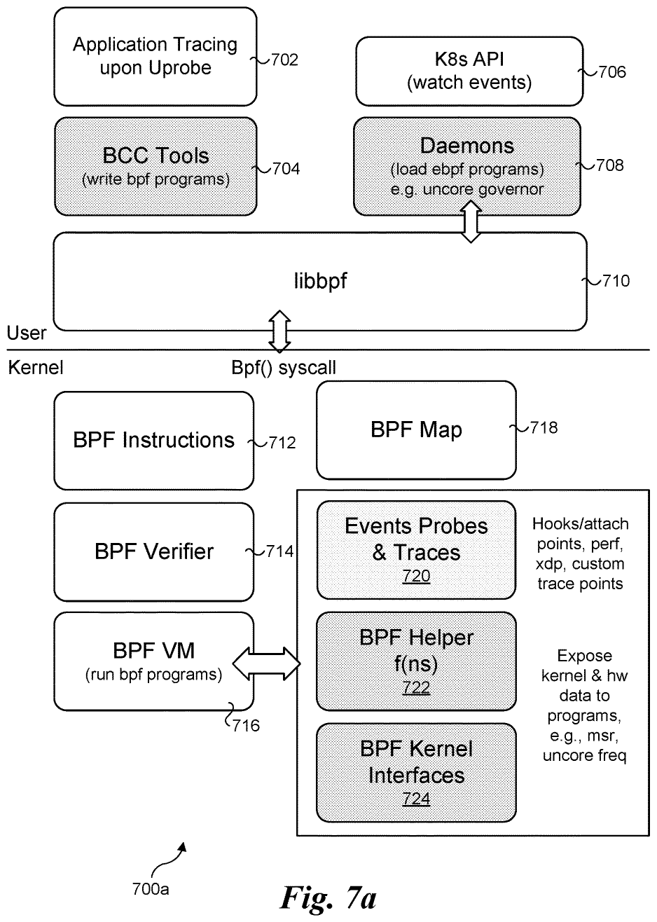

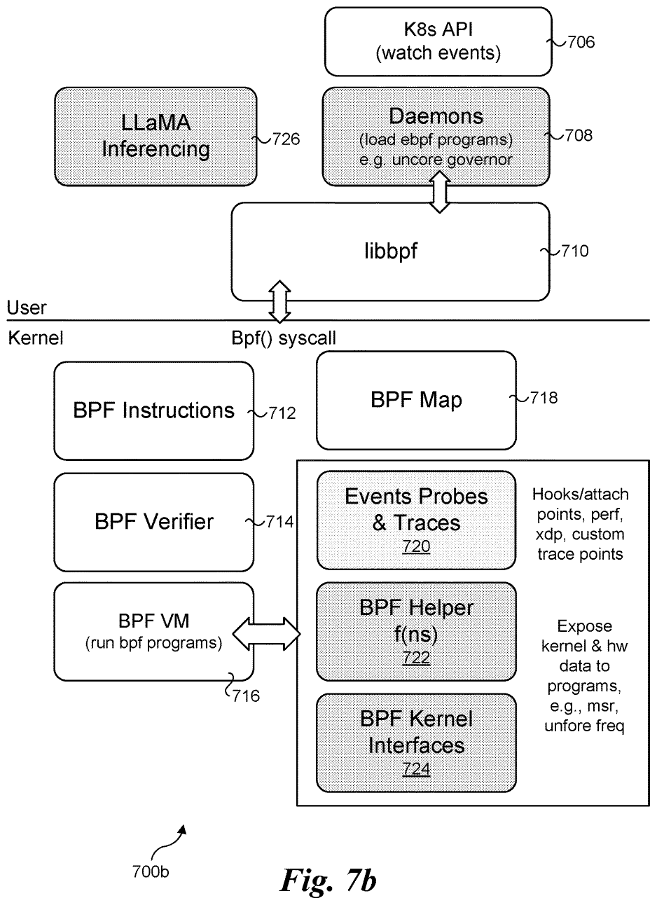

FIG. 7a shows a software architecture 700a that is used by some embodiments. The architecture is divided into user space and kernel space. In this diagram and the diagram for software architecture 700b of FIG. 7b, components shown with a white background are existing components while components shown with a gray background are new components.

The user space components include application tracing upon Uprobe 702, BCC tools 704 that are used to write bpf programs), K8s API (watch events) 706, daemons 708 and llbbpf 710. Existing kernel components include BPF instructions 712, a BPF verifier 714, a BPF virtual machine (VM) 716, and a BPF map 718. New kernel components include events probes and traces 720, BPF helper functions 722, and BPF kernel interfaces 724. Events probes and traces 720 comprise kernel hooks/attach points, perf, xdp (eXpress data path), and custom trace points. BPF helper functions 722 and BPF kernel interfaces 724 expose kernel and hardware data to program, such as MSR and uncore frequency.

As further shown in architecture diagrams 700a and 700b, llbbpf communicates with kernel components using Bpf( ) syscalls.

Like-numbered components in software architectures 700a of FIGS. 7a and 700b of FIG. 7b are the same or similar components under both software architectures. Software architectures 700b further includes LLaMA inferencing 726, which is an example of inferencing for a Large Language Model (LLM).

### Example Platform/Compute Node

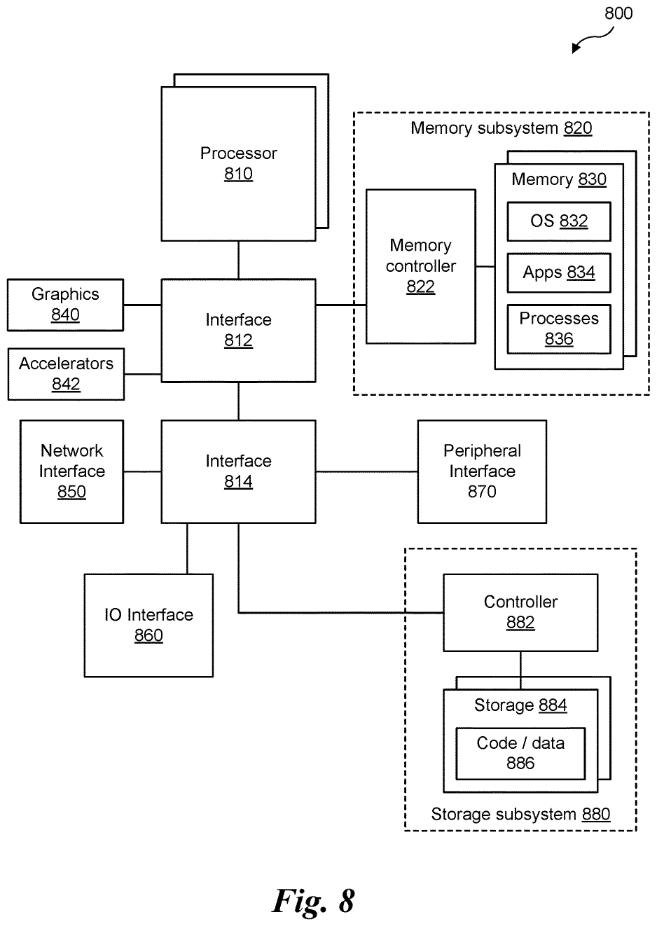

FIG. 8 depicts a compute node 800 in which aspects of the embodiments disclosed above may be implemented. Compute node 800, also referred to as a compute platform, includes one or more processors 810, which provides processing, operation management, and execution of instructions for compute node 800. Processor 810 can include any type of microprocessor, central processing unit (CPU), graphics processing unit (GPU), processing core, multi-core processor or other processing hardware to provide processing for compute node 800, or a combination of processors. For the embodiments herein, processor 810 is a multi-core processor comprising a System on a Chip (SoC) or System on Package (SoP). Processor 810 controls the overall operation of compute node 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, compute node 800 includes interface 812 coupled to processor 810, which can represent a higher speed interface or a high throughput interface for system components that needs higher bandwidth connections, such as memory subsystem 820 or optional graphics interface 840 components, or optional accelerators 842. Interface 812 represents an interface circuit, which can be a standalone component or integrated onto a processor die. Where present, graphics interface 840 interfaces to graphics components for providing a visual display to a user of compute node 800. In one example, graphics interface 840 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

In some embodiments, accelerators 842 can be a fixed function offload engine that can be accessed or used by a processor 810. For example, an accelerator among accelerators 842 can provide data compression capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 820 represents the main memory of compute node 800 and provides storage for code to be executed by processor 810, or data values to be used in executing a routine. Memory subsystem 820 can include memory 830 with one or more memory devices such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in compute node 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for compute node 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

While not specifically illustrated, it will be understood that compute node 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, compute node 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides compute node 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. Various embodiments can be used in connection with network interface 850, processor 810, and memory subsystem 820.

In one example, compute node 800 includes one or more IO interface(s) 860. IO interface 860 can include one or more interface components through which a user interacts with compute node 800 (e.g., audio, alphanumeric, tactile/touch, or other interfacing). Peripheral interface 870 can include any hardware interface not specifically mentioned above. Peripherals refer generally to devices that connect dependently to compute node 800. A dependent connection is one where compute node 800 provides the software platform or hardware platform or both on which operation executes, and with which a user interacts.

In one example, compute node 800 includes storage subsystem 880 to store data in a nonvolatile manner. In one example, in certain system implementations, at least certain components of storage subsystem 880 can overlap with components of memory subsystem 820. Storage subsystem 880 includes storage 884 including one or more storage devices, which can be or include any conventional medium for storing large amounts of data in a nonvolatile manner, such as one or more magnetic, solid state, or optical based disks, or a combination. Storage 884 holds code or instructions and data 886 in a persistent state (i.e., the value is retained despite interruption of power to compute node 800). Storage 884 can be generically considered to be a “memory,” although memory 830 is typically the executing or operating memory to provide instructions to processor 810. Whereas storage 884 is nonvolatile, memory 830 can include volatile memory (i.e., the value or state of the data is indeterminate if power is interrupted to compute node 800). In one example, storage subsystem 880 includes controller 882 to interface with storage 884. In one example controller 882 is a physical part of interface 814 or processor 810 or can include circuits or logic in both processor 810 and interface 814.

Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory, JESD235B, originally published in December 2018, HBM2 (HBM version 2, JESD235D, originally published in March 2021, HBM3 (HBM version 3, JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of compute node 800. More specifically, power source typically interfaces to one or multiple power supplies in compute node 800 to provide power to the components of compute node 800. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, compute node 800 can be implemented using interconnected compute sleds of processors, memories, storages, network interfaces, and other components. In some implementations, a disaggregated architecture under which compute, memory, and storage and pooled in respective interconnect sleds or chassis in racks. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

While the embodiments described and illustrated herein refer to Linux eBPF components, similar eBPF components may be implemented in versions of Windows operating systems supporting eBPF. As an alternative, a CPU or other hardware device can collect applicable telemetry data without using eBPF components, calculate core capacity, and present this metric in a register or software/firmware readable interface.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”). In some instances, including the claims, the terms CPU and SoC or SoP are interchangeable.

In addition to use with CPUs, the teaching and principles disclosed herein may be applied to Other Processing Units (collectively termed XPUs) including one or more of Graphic Processor Units (GPUs) or General Purpose GPUs (GP-GPUs), Tensor Processing Units (TPUs), Data Processing Units (DPUs), Infrastructure Processing Units (IPUs), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments may be used as or to support a software program, software modules, firmware, and/or distributed software executed upon some form of processor, processing core, or embedded logic, or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the embodiments to the precise forms disclosed. While specific embodiments of, and examples for, the teachings and principles are described herein for illustrative purposes, various equivalent modifications are possible within the scope of the claims, as those skilled in the relevant art will recognize.

These modifications can be made to the embodiments in light of the above detailed description. The terms used in the following claims should not be construed to limit the claim scope to the specific embodiments disclosed in the specification and the drawings. Rather, the scope of the claims is to be determined entirely by the following claims, which are to be construed in accordance with established doctrines of claim interpretation.

What is claimed is:

1. A method for determining core capacity of a processor core having an adjustable frequency including a base frequency and a turbo limit frequency, comprising:
determining a core capacity of a core by,
accessing a current utilization of a core;
accessing a current frequency of the core;
determining a headroom based at least in part as a function of the current utilization and current frequency; and
determining the core capacity based at least in part as a function of the current headroom and one of the base frequency or the turbo limit frequency.

2. The method of claim 1, wherein the headroom is calculated as the current utilization times the current frequency.

3. The method of claim 1, wherein the processor core is used to execute one or more processes comprising a workload, further comprising utilizing the core capacity in a closed-loop control process to adjust the frequency of the core in response to changes in the workload.

4. The method of claim 3, wherein the closed-loop control process includes alarm logic that utilizes a threshold to issue an alarm when the calculated core capacity exceeds the threshold.

5. The method of claim 4, wherein in response issuance of the alarm, the core frequency is set to the base frequency or the turbo limit frequency.

6. The method of claim 1, wherein the processor comprises a central processing unit (CPU) of a compute platform on which workloads are run, and at least one of detecting the current utilization of the core and detecting the current frequency of the core is facilitated by a collecting telemetry data relating to power management and performance metrics for the CPU.

7. The method of claim 6, wherein collecting the telemetry data relating to power management and performance metrics comprises attaching an extended Berkley Packet Filter (eBPF) governor.

8. The method of claim 1, wherein the processor core is in a central processing unit (CPU).

9. The method of claim 1, wherein the processor core is in a processing unit comprising an other processing unit (XPU) comprising a Graphic Processor Unit (GPU), General Purpose GPU, a Tensor Processing Unit (TPU), a Data Processing Unit, and Infrastructure Processing Unit IPU, an Artificial Intelligence (AI) processor or AI inference unit, or an accelerator.

10. A non-transitory machine-readable medium having instruction stored thereon to be executed on a central processing unit (CPU) having a plurality of processor cores including processor cores that are configurable to be operated at different frequencies including a base frequency and a turbo limit frequency, wherein execution of the instructions on the CPU enable the CPU to:
determine a core capacity of a core by,
access a current utilization of a core;
access a current frequency of the core;
determine a headroom based at least in part as a function of the current utilization and current frequency; and
determine the core capacity based at least in part as a function of the current headroom and one of the base frequency or the turbo limit frequency.

11. The non-transitory machine-readable medium of claim 10, wherein the headroom is calculated as the current utilization times the current frequency.

12. The non-transitory machine-readable medium of claim 10, wherein the processor core is used to execute one or more processes comprising a workload, further comprising utilizing the core capacity in a closed-loop control process to adjust the frequency of the core in response to changes in the workload.

13. The non-transitory machine-readable medium of claim 12, wherein the closed-loop control process includes alarm logic that utilizes a threshold to issue an alarm when the calculated core capacity exceeds the threshold.

14. The non-transitory machine-readable medium of claim 13, wherein in response issuance of the alarm, the core frequency is set to the base frequency or the turbo limit frequency.

15. The non-transitory machine-readable medium of claim 10, wherein the CPU is installed in a compute platform on which workloads are run, and wherein at least one of detecting the current utilization of the core and detecting the current frequency of the core is facilitated by a collecting telemetry data relating to power management and performance metrics for the CPU.

16. The non-transitory machine-readable medium of claim 15, wherein a portion of the instructions comprises an extended Berkley Packet Filter (eBPF) governor that is used, at least in part, to collect the telemetry data relating to power management and performance metrics for the CPU.

17. A compute platform, comprising:
a central processing unit (CPU) having a plurality of CPU cores and circuitry external to the plurality of CPU cores comprising an uncore;
memory, operatively coupled to the processor;
instructions, including an operating system, loaded in the memory or stored in a storage device operatively coupled to the CPU and configured to be executed on processor cores among the plurality of processor cores to enable the compute platform to:
access a current utilization of a core;
access a current frequency of the core;
determine a headroom based at least in part as a function of the current utilization and current frequency; and
determine a core capacity based at least in part as a function of the current headroom and one of the base frequency or the turbo limit frequency.

18. The compute platform of claim 10, wherein the processor core is used to execute one or more processes comprising a workload, further comprising utilizing the core capacity in a closed-loop control process to adjust the frequency of the core in response to changes in the workload.

19. The compute platform of claim 18, wherein the closed-loop control process includes alarm logic that utilizes a threshold to issue an alarm when the calculated core capacity exceeds the threshold.

20. The compute platform of claim 19, wherein in response issuance of the alarm, the core frequency is set to the base frequency or the turbo limit frequency.
